(19) United States
(12) Patent Application Publication
(10) Pub. No.: US 2026/0056953 A1
(43) Pub. Date: Feb. 26, 2026

(54) QUERY ISOLATION LAYER SERVICE

(71) Applicant: INTERNATIONAL BUSINESS MACHINES CORPORATION, ARMONK, NY (US)

(72) Inventors: Mary Ellen Najewicz, Wendell, NC (US); Jim Episale, Apex, NC (US)

(21) Appl. No.: 18/815,274

(22) Filed: Aug. 26, 2024

(51) Int. Cl. G06F 16/2455; G06F 16/25

(52) U.S. Cl. CPC G06F 16/2455; G06F 16/258

(57) ABSTRACT

Described are techniques for query management. The techniques include identifying, in a query database, a first query associated with an identifier, a version number, and parameters received from a front-end application, where the query database stores a plurality of preconfigured queries and is communicatively coupled to the front-end application and a plurality of databases. The techniques further include executing the first query by implementing database query code associated with the first query against one or more target databases of the plurality of databases, where executing the first query returns retrieved data. The techniques further include transmitting the retrieved data in a format of returned data selected from a plurality of formats to a user device associated with the front-end application

### BACKGROUND

The present disclosure relates to databases, and, more specifically, to database queries.

Queries are used to access data in a database. A query can be used to retrieve relevant data and use it for some other purpose. A query can include query parameters to identify what data to retrieve from a database. Queries can be written in Structured Query Language (SQL), Non-SQL (NoSQL), and/or other query languages.

### SUMMARY

In some aspects, the techniques described herein relate to a computer-implemented method comprising identifying, in a query database, a first query associated with an identifier, a version number, and parameters received from a front-end application, where the query database stores a plurality of preconfigured queries and is communicatively coupled to the front-end application and a plurality of databases. The computer-implemented method further comprises executing the first query by implementing database query code associated with the first query against one or more target databases of the plurality of databases, where executing the first query returns retrieved data. The computer-implemented method further comprises transmitting the retrieved data in a format of returned data selected from a plurality of formats to a user device associated with the front-end application.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system for query management, in accordance with some embodiments of the present disclosure.

FIG. 2 illustrates an example table of information an application utilizes to interface with a Query Isolation Layer (QIL) service, in accordance with some embodiments of the present disclosure.

FIG. 3 illustrates an example QIL service database table, in accordance with some embodiments of the present disclosure.

FIG. 4 illustrates a flowchart of an example method for query management, in accordance with some embodiments of the present disclosure.

FIG. 5 illustrates a flowchart of an example method for downloading, deploying, metering usage, and invoicing query management code, in accordance with some embodiments of the present disclosure.

FIG. 6 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward databases, and, more specifically, to database queries. While not limited to such applications, embodiments of the present disclosure may be better understood in light of the aforementioned context.

Extracting data from a database is an essential feature for many software implementations such as, but not limited to, applications, Extract-Transfer-Load (ETL) processes, and Artificial Intelligence (AI) projects. However, different data queries (and the software implementations that call them) become increasingly complex with larger implementations. Simplification and management of data queries at scale is a technological need in numerous industries.

Aspects of the present disclosure are designed to address the aforementioned need. For simplicity, aspects of the present disclosure will be discussed in relationship to applications. However, alternative and/or additional software implementations can likewise be used with the present disclosure without limitation. Aspects of the present disclosure can remove queries from an application's codebase, and the queries can instead be independently maintained in a query database. In doing so, aspects of the present disclosure can improve query performance insofar as queries can be iteratively and/or independently optimized for performance separately from development of an application. Additionally, aspects of the present disclosure can reduce maintenance by decoupling query updates from updates to an application's codebase.

Aspects of the present disclosure are especially advantageous as applications scale. In other words, as more data is stored in databases, and as queries become more complex to accurately retrieve the desired data, aspects of the present disclosure advantageously reduce code changes, reduce overhead costs as a result of sustaining a smaller codebase, and improve query management for complex systems. Collectively, aspects of the present disclosure improve efficiency and accuracy of executing complex database queries.

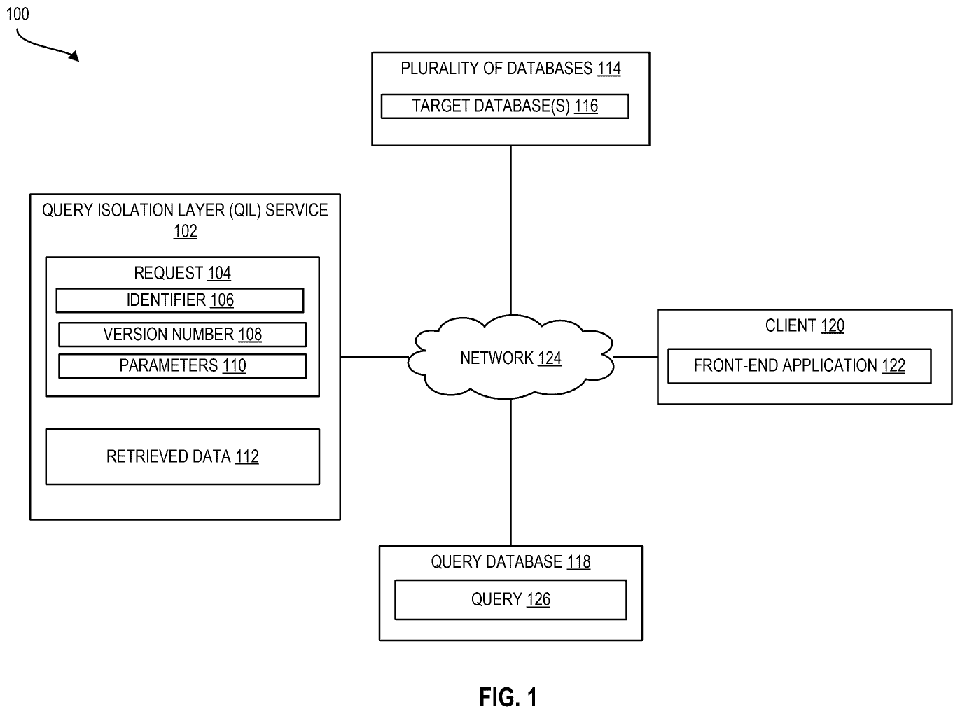

More generally, as previously discussed, aspects of the present disclosure can isolate queries from the backend codebase of an associated application so that the queries can be maintained independently. All query information and query code can thus be held in a query database together with supporting information related to the query. With this structure for independently storing queries in a query database, queries (e.g., data reads) can be updated, tuned, optimized, and/or deleted without impacting the codebase of the associated application. Thus, instead of creating unique applications and Application Programming Interfaces (APIs) to implement queries, there is a singular query database service (e.g., QIL service 102 of FIG. 1) interfacing with a query database (e.g., query database 118 of FIG. 1) that is reused by multiple applications to retrieve data from many databases. Aspects of the present disclosure thus enable queries to be optimized (e.g., performance tuning, alterations to better align with indexes, updating, etc.) independently from applications that interact with the database(s). Aspects of the present disclosure can be used to manage SQL queries against any relational database (e.g., DB2®, MySQL®, PostgreSQL®, Oracle® Database, Amazon Aurora®, etc.) and/or queries against NoSQL databases (e.g., Cloudant®, MongoDB®, Apache CouchDB®, Apache Cassandra®, Redis®, etc.).

Aspects of the present disclosure can realize numerous technical benefits. For example, aspects of the present disclosure can isolate queries from a backend codebase so that they can be managed independently. This can allow development teams flexibility by decoupling queries from the codebase. As a further advantage, aspects of the present disclosure are technology agnostic. In other words, aspects of the present disclosure can work on any platform (e.g., Public Cloud, Private Cloud, On-Premise, etc.) or database technology including both SQL and NoSQL offerings. As a further advantage, all query logic can be held in a database table along with supporting information related to the query. This structure advantageously componentizes queries into consumable units of work that are more readily integrated into a business process. As an additional advantage, aspects of the present disclosure can provide clear versioning of all queries, thereby creating a centralized audit trail for any query changes. As yet another example advantage, aspects of the present disclosure can provide universal data retrieval functionality that can be reused to interface multiple applications to different databases.

In one example implementation, aspects of the present disclosure are estimated to reduce participating applications' total codebase by 42% and reduce the codebase specifically for data retrieval processes by 80-90%. The reduction in codebase size results in less maintenance and debugging required by developers-saving each developer an estimated 104 hours each year. Finally, aspects of the present disclosure improve the security of applications by reducing the attack surface of the associated applications and enforcing input sanitization for interactions between the application and the query database service.

Aspects of the present disclosure are distinct from the current state of technology. For example, while some existing solutions address the issue of reducing code related to data retrieval by eliminating redundant searches, aspects of the present disclosure instead remove queries from the codebase to eliminate unique backend processes for different data retrievals. In doing so, aspects of the present disclosure realize a methodology to manage a system with hundreds or thousands of unique queries with a reusable service for queries (e.g., data reads) and a centralized repository for all query logic.

As another example, some existing solutions utilize APIs to remove reliance on manual categorization of business capabilities. In contrast, aspects of the present disclosure enforce a foundation that supports a singular practice for all queries (e.g., data reads) that can be replicated as needed to support a workflow. Additionally, aspects of the present disclosure separate the query logic from the backend codebase which allows teams to improve upon the query logic and the backend codebase independently.

Referring now to the figures, FIG. 1 illustrates a block diagram of an example system 100 for query management, in accordance with some embodiments of the present disclosure. The system 100 includes a Query Isolation Layer (QIL) service 102, a plurality of databases 114, a query database 118, and a client 120 communicatively coupled to one another (directly or indirectly) via one or more continuous or intermittent networks 124.

The QIL service 102, plurality of databases 114, query database 118, and client 120 can comprise physical and/or virtual computational resources such as processors, storage, network, and/or other resources. QIL service 102, plurality of databases 114, query database 118, and client 120 can further include computer-readable and/or computer-executable content that is saved in physical or virtual storage resources and executable to realize aspects of the present disclosure. The client 120 can be, for example, a user device such as, but not limited to, a laptop, desktop, smartphone, tablet, or the like.

Although the QIL service 102, plurality of databases 114, query database 118, and client 120 are shown separately, in various embodiments the aforementioned components (including more or fewer components than the components shown) can be integrated together in different configurations than the configurations shown. For example, aspects of the present disclosure can reside within client 120, where the client 120 downloads computer-executable program code to run various elements of FIG. 1 (e.g., QIL service 102) within the client 120. As another example, query database 118 can be stored as part of QIL service 102.

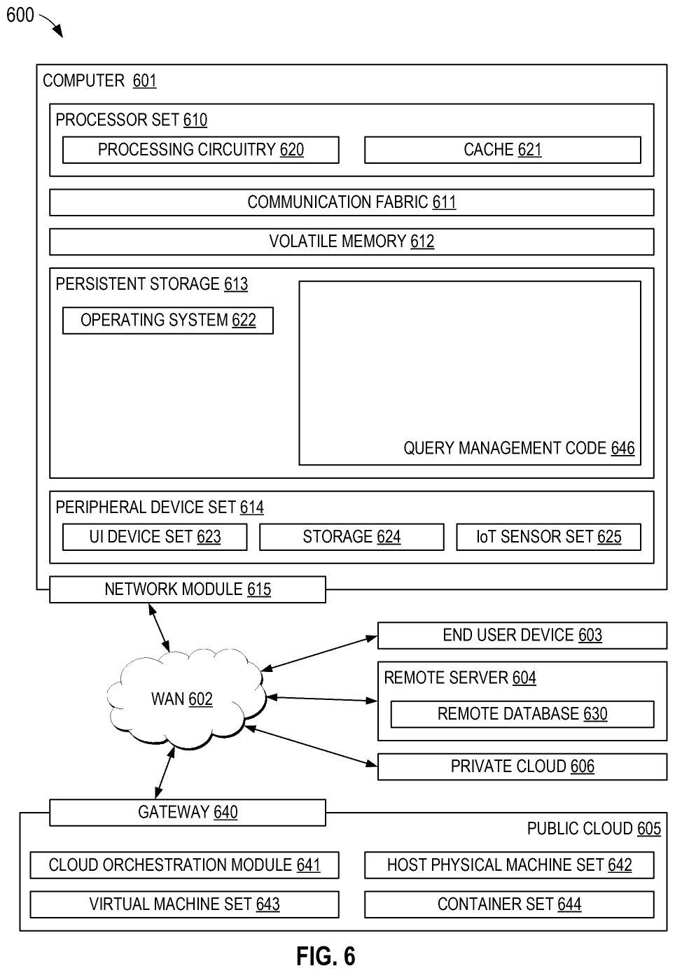

Network 124 can be a local area network (LAN), a wide area network (WAN), an intranet, the Internet, or any other network 124 or group of networks 124 capable of continuously, semi-continuously, or intermittently connecting (directly or indirectly) the QIL service 102, plurality of databases 114, query database 118, and client 120. In some embodiments, network 124 is consistent with WAN 602 of FIG. 6.

Aspects of FIG. 1 can manage and execute queries (e.g., SQL, NoSQL, etc.) against a plurality of databases 114 (e.g., backend databases). Advantageously, aspects of the present disclosure can execute queries regardless of the query's complexity, return structure, or data transformation requirements.

To begin, QIL service 102 intakes a request 104 from a front-end application 122 executing on the client 120. The front-end application 122 can be any application, service, or other set of computer-executable code that is configured to utilize data retrieved from a database. The request 104 can be manually or automatically initiated. When automatically initiated, the request 104 can be triggered by an action such as, but not limited to, logging into an application, initiating a data transfer, pulling training data for an AI or Machine Learning (ML) algorithm, and the like. In such arrangements, the QIL service 102 can function as a microservice supporting the front-end application 122.

The request 104 can include an identifier 106, version number 108, and/or parameters 110 which can be used to identify the corresponding, preconfigured query 126 in a query database 118 and identify one or more target database(s) 116 of the plurality of databases 114 against which to implement the query 126. After executing the query 126 against the target database(s) 116, the QIL service 102 can transmit the retrieved data 112 to the front-end application 122 of the client 120. In some embodiments, the retrieved data 112 is streamed to the front-end application 122 of the client 120.

In this way, the front-end application 122 delegates query management to the QIL service 102. More specifically, the QIL service 102 identifies the appropriate query 126 from the query database 118 based on the request 104 from the front-end application 122. The QIL service 102 executes the appropriate query 126 against the target database(s) 116 of the plurality of databases 114 and provides the retrieved data 112 to the front-end application 122.

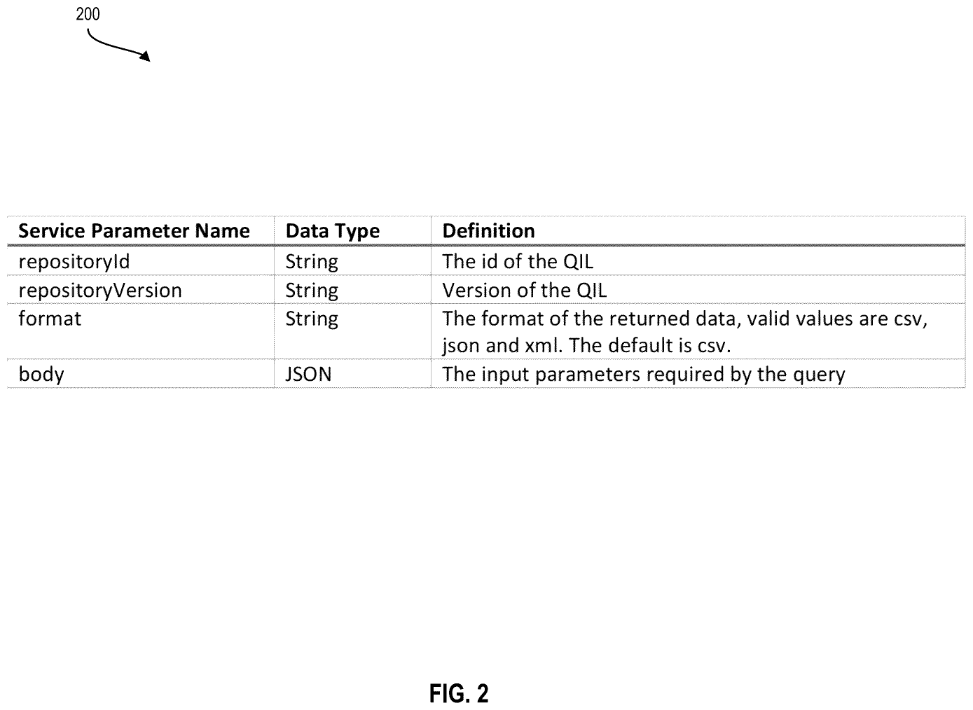

FIG. 2 illustrates an example table 200 of information an application (e.g., front-end application 122 of FIG. 1) utilizes to interface with a Query Isolation Layer (QIL) service (e.g., QIL service 102 of FIG. 1), in accordance with some embodiments of the present disclosure. Table 200 can include repositoryID, repository Version, format, and body, among other parameters. RepositoryID can have data type of “string” and example definition of “the id of the QIL”. In some embodiments, RepositoryID can be consistent with identifier 106 of FIG. 1. Repository Version can have data type of “string” and example definition of “version of the QIL”. In some embodiments, Repository Version can be consistent with version number 108 of FIG. 1. Format can have data type of “string” and example definition of “the format of the returned data, valid values are csv, json, and xml. The default is csv”. Body can have data type of “JSON” and example definition of “the input parameters required by the query”. In some embodiments, format and body as shown in table 200 can be consistent with parameters 110 of FIG. 1.

Advantageously, aspects of the present disclosure can impair cyberattacks such as SQL injection by sanitizing user inputs to only allow expected arguments to be passed through to the service. In other words, by requiring an application (e.g., front-end application 122 of FIG. 1) to obtain information from a QIL service (e.g., QIL service 102 of FIG. 1) according to the information specified in table 200, aspects of the present disclosure reduce an external actor's ability to maliciously utilize SQL injection. Additionally, as shown in FIG. 2, by requiring a repositoryID and repository Version (instead of running a specific search for X fields in Y tables), aspects of the present disclosure separate the query logic from the codebase and limit the complexity of the code, thereby resulting in fewer bugs and vulnerabilities. Collectively, these elements of the present disclosure reflect the security principle of least functionality, thereby realizing a more secure alternative than traditional data retrieval processes.

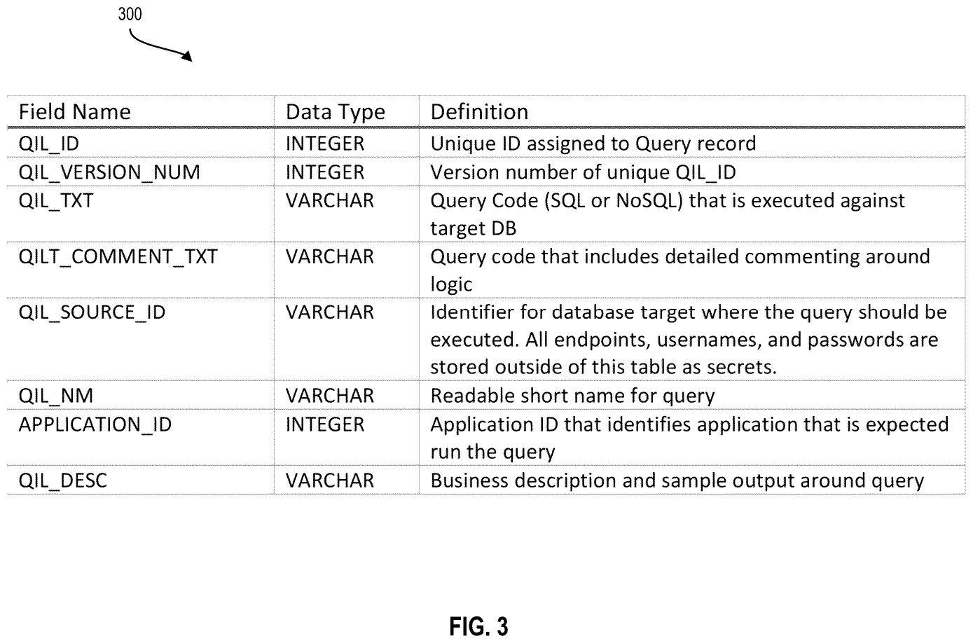

FIG. 3 illustrates an example QIL service database table 300, in accordance with some embodiments of the present disclosure. QIL service database table 300 includes, for example, QIL_ID, QIL_VERSION_NUM, QIL_TXT, QIL_COMMENT_TXT, QIL_SOURCE_ID, QIL_NM, APPLICATION_ID, and QIL_DESC.

QIL_ID can be an integer string that provides a unique identifier to a query record. QIL_VERSION_NUM can be an integer string that identifies a version number of a QIL_ID. QIL_TXT can be a variable character string including the SQL or NoSQL query code that is executed against one or more target databases. QIL_COMMENT_TXT can be a variable character string comprising query code with detailed commentary related to the logic of the query code. QIL_SOURCE_ID can be a variable character string identifying one or more target databases that the query should be executed against. Endpoints, usernames, and passwords can be stored outside of the QIL service database table 300 as secrets. QIL_NM can be a variable character string that functions as a readable short name for the query. APPLICATION_ID can be an integer string that identifies an application that is expected to run the query. QIL_DESC can be a variable character string that includes a business description and sample output related to the query. Each query (e.g., query 126 of FIG. 1) in a query database (e.g., query database 118 of FIG. 1) can have some or all of the aforementioned fields associated with it.

As discussed previously, aspects of the present disclosure enable efficient maintenance and increased accuracy for query management. However, as shown in FIG. 3, the QIL service database table 300 additionally enables clear documentation associated with each backend read process. By ingraining documentation in the QIL service database table 300, users benefit from increased understanding of each query. Additionally, the QIL service database table 300 can be used as a trusted audit source. For example, the QIL service database table 300 can reflect changes to processes over time and track the information being pulled by front-end applications and users.

As one example of improved auditability, each query configured in the QIL service database table 300 is given a version number (QIL_VERSION_NUM). Not only does the version number enable improved tracking and auditing of query changes, but it also helps alleviate application updates. For example, if an application has a new query requirement, aspects of the present disclosure can update the query to meet the new query requirement and add it to the QIL service database table 300 with an incremented version number. As a result, the application can call the most recent version of the query for the parts of the application that are ready for the updated query that satisfies the new query requirement. Alternatively, if an application still needs to refer to an older version of a query, the older version can be referenced instead (e.g., for staggered deployments). This functionality leads to faster and more flexible development practices that align with iterative application development. Additionally, storing historic versions of a query allows applications to have a straightforward rollback strategy. For example, if a current updated query fails in production, the application can call a previous version of the query to restore functionality.

Furthermore, aspects of the present disclosure allow applications to implement database queries based on componentized pieces from distributed sources. For example, if a user requires data from two different sources that are independent of one another, aspects of the present disclosure can run two parallel queries. Each query can point to two different databases where the information resides. For example, as shown in FIG. 3, one or more database(s) against which to execute a query can be defined in QIL_SOURCE_ID in the QIL service database table 300. Without the functionality provided by aspects of the present disclosure, one would have to complete ETL so that both pieces of information reside in the same database, thereby enabling the aforementioned search to be supported by one backend service. In contrast, aspects of the present disclosure grant applications the flexibility to break searches into smaller logical units of work and easily maintain each query component individually. Accordingly, aspects of the present disclosure fit well in a distributed data environment that allows applications to avoid central repositories and reduce data replication processes.

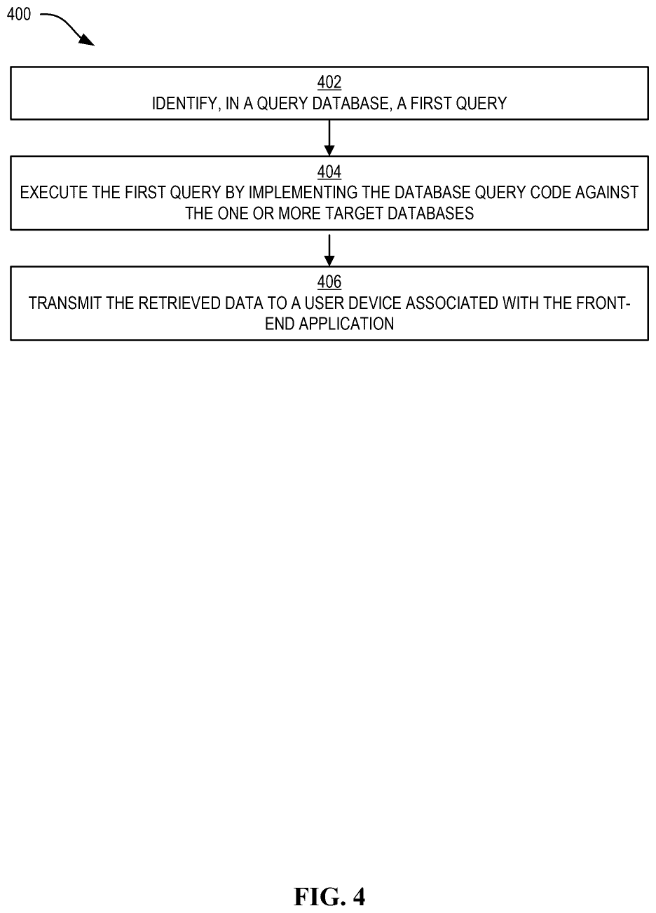

FIG. 4 illustrates a flowchart of an example method 400 for query management, in accordance with some embodiments of the present disclosure. The method 400 can be implemented by, for example, a QIL service (e.g., QIL service 102) and/or other components of FIG. 1, one or more computers (e.g., computer 601 of FIG. 6), one or more processors, and/or another configuration of hardware and/or software.

Operation 402 includes identifying, in a query database, a first query. In some embodiments, operation 402 identifies the first query based on a request including an identifier, a version number, and parameters received from a front-end application. In some embodiments, the identifier can be a repositoryID, the version number can be a repository Version, and the parameters can be a format and a body (as shown in FIG. 2). In some embodiments, the query database stores a plurality of preconfigured queries and is communicatively coupled to the front-end application and a plurality of databases. In some embodiments, the query database comprises, for the first query, the identifier, the version number, a format of returned data selected from the plurality of formats, one or more target databases of a plurality of databases, database query code, commentary associated with the database query code, a name for the first query, and an identification of the front-end application associated with the first query.

The query database can store queries with SQL database query code and/or NoSQL database query code, according to various embodiments. Regardless, the query database is managed independently of a codebase associated with the front-end application. Furthermore, in some embodiments, the query database automatically interacts with the front-end application as a microservice.

Operation 404 includes executing the first query by implementing the database query code against the one or more target databases. Operation 404 can return retrieved data as a result of executing the first query.

Operation 406 includes transmitting the retrieved data to a user device associated with the front-end application. In some embodiments, operation 406 streams the retrieved data to the user device associated with the front-end application. Aspects of the present disclosure utilize data streaming in order to reliably return data to the user regardless of quantity. Data streaming capabilities can prevent crashing and memory limitation issues, thereby enabling aspects of the present disclosure to retrieve many rows of data (e.g., tens of thousands of rows). As rows of data are pulled, they can be immediately streamed back to the front-end application (e.g., front-end application 122 of FIG. 1) such that no data is stored in the memory of the QIL service (e.g., QIL service 102 of FIG. 1). Nonetheless, aspects of the present disclosure can additionally, or alternatively, be configured to utilize data batching in the query itself to improve the performance of large data pulls. However, the configurability of the query to enable batching requires customization that may not occur. Thus, data streaming provides a failsafe mechanism to safeguard the performance and resiliency of the service.

Furthermore, aspects of the present disclosure can also return a query in multiple different outputs. The same query can be shared across many applications, but because applications have different technology stacks, different applications may require the query output in different formats. Aspects of the present disclosure can return data in multiple different outputs such as, but not limited to, delimited file, JSON, BSON, BLOB, and the like. Clients can determine the output type as an input parameter (e.g., parameters 110 of FIG. 1, “format” of FIG. 2) to get a desired format for a given application. Advantageously, aspects of the present disclosure can thus convert specialized outputs from legacy systems to usable data. In addition, customizable query output (as enabled by aspects of the present disclosure) can facilitate application migration insofar as database query code need not be rewritten as part of the migration. Instead, queries can be updated to a new format using aspects of the present disclosure during the migration process.

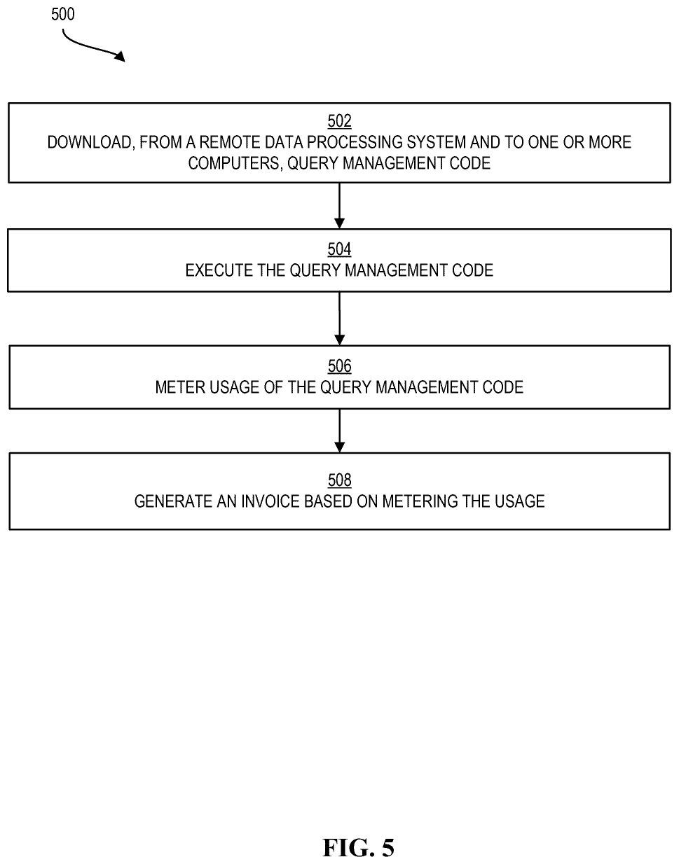

FIG. 5 illustrates a flowchart of an example method 500 for downloading, deploying, metering, and billing usage of query management code, in accordance with some embodiments of the present disclosure. The method 500 can be implemented by one or more components of FIG. 1 (e.g., QIL service 102 of FIG. 1), a computer (e.g., computer 601 of FIG. 6), one or more processors, and/or another configuration of hardware and/or software. In some embodiments, the method 500 occurs contemporaneously with any of the aforementioned methods.

Operation 502 includes downloading, from a remote data processing system and to one or more computers (e.g., QIL service 102 of FIG. 1, client 120 of FIG. 1, computer 601 of FIG. 6, etc.) query management code (e.g., query management code 646 of FIG. 6). Operation 504 includes executing the query management code. The executing can include performing any of the methods and/or functionalities discussed herein. Operation 506 includes metering usage of the query management code. Usage can be metered by, for example, an amount of time the query management code is used, a number of servers, devices, and/or nodes deploying the query management code, an amount of resources consumed by implementing the query management code, a number of queries executed by the query management code, an amount of data retrieved via the execution of the queries by the query management code, and the like. Operation 508 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 illustrates a block diagram of an example computing environment, in accordance with some embodiments of the present disclosure. Computing environment 600 contains an example of an environment for the execution of at least some of the computer code involved in performing the inventive methods, such as query management code 646. In addition to query management code 646, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and query management code 646, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in query management code 646 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in query management code 646 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

Some example embodiments will now be described. Clause 1 is a computer-implemented method. The computer-implemented method includes identifying, in a query database, a first query associated with an identifier, a version number, and parameters received from a front-end application, wherein the query database stores a plurality of preconfigured queries and is communicatively coupled to the front-end application and a plurality of databases; executing the first query by implementing database query code associated with the first query against one or more target databases of the plurality of databases, wherein executing the first query returns retrieved data; and transmitting the retrieved data in a format of returned data selected from a plurality of formats to a user device associated with the front-end application.

Clause 2 includes the features of clause 1. In this example, the retrieved data is transmitted to the user device by streaming the retrieved data to the user device.

Clause 3 includes the features of any one of clauses 1 to 2. In this example, the query database comprises, for the first query, the identifier, the version number, the format of returned data selected from the plurality of formats, the one or more target databases of the plurality of databases, the database query code, commentary associated with the database query code, a name for the first query, and an identification of the front-end application associated with the first query.

Clause 4 includes the features of any one of clauses 1 to 3. In this example, the query database stores queries with Structured Query Language (SQL) database query code and Non-SQL (NoSQL) database query code.

Clause 5 includes the features of any one of clauses 1 to 4. In this example, the query database is managed independently of a codebase associated with the front-end application.

Clause 6 includes the features of any one of clauses 1 to 5. In this example, the query database automatically interacts with the front-end application as a microservice.

Clause 7 includes the features of any one of clauses 1 to 6. In this example, the computer-implemented method is executed by a computational system based on query management code downloaded to the computational system from a remote data processing system. Optionally, the computer-implemented method further comprises: metering usage of the query management code; and generating an invoice based on metering the usage of the query management code.

Clause 8 is a system comprising one or more processors and one or more computer-readable storage media storing program instructions which, when executed by the one or more processors, are configured to cause the one or more processors to perform a method according to any one of clauses 1 to 7.

Clause 9 is a computer program product comprising one or more computer readable storage media, and program instructions collectively stored on the one or more computer readable storage media, the program instructions comprising instructions configured to cause one or more processors to perform a method according to any one of clauses 1 to 7.

1. A computer-implemented method comprising:
identifying, in a query database, a first query associated with an identifier, a version number of the first query, and parameters received from a front-end application, wherein the parameters comprise a format of returned data selected from a plurality of formats and a body comprising input parameters required by the first query, wherein the query database stores a plurality of preconfigured queries and is communicatively coupled to the front-end application and a plurality of databases, and wherein the query database comprises, for the first query, the identifier, the version number, the format of returned data selected from the plurality of formats comprising delimited file, JSON, BSON, and BLOB, one or more target databases of the plurality of databases, database query code, commentary related to logic associated with the database query code, a name for the first query, and an identification of the front-end application associated with the first query;
executing the first query by implementing the database query code associated with the first query against the one or more target databases of the plurality of databases, wherein executing the first query returns retrieved data; and
transmitting the retrieved data in the format of returned data to a user device associated with the front-end application.

2. The computer-implemented method of claim 1, wherein the retrieved data is transmitted to the user device by streaming the retrieved data to the user device.

3. (canceled)

4. The computer-implemented method of claim 1, wherein the query database stores queries with Structured Query Language (SQL) database query code and Non-SQL (NoSQL) database query code.

5. The computer-implemented method of claim 1, wherein the query database is managed independently of a codebase associated with the front-end application.

6. The computer-implemented method of claim 1, wherein the query database automatically interacts with the front-end application as a microservice.

7. The computer-implemented method of claim 1, wherein the computer-implemented method is executed by a computational system based on query management code downloaded to the computational system from a remote data processing system, and wherein the computer-implemented method further comprises:
metering usage of the query management code; and
generating an invoice based on metering the usage of the query management code.

8. (canceled)

9. A system comprising:
one or more processors; and
one or more computer-readable storage media storing program instructions which, when executed by the one or more processors, are configured to cause the one or more processors to perform a method comprising:
identifying, in a query database, a first query associated with an identifier, a version number of the first query, and parameters received from a front-end application, wherein the parameters comprise a format of returned data selected from a plurality of formats and a body comprising input parameters required by the first query, wherein the query database stores a plurality of preconfigured queries and is communicatively coupled to the front-end application and a plurality of databases, and wherein the query database comprises, for the first query, the identifier, the version number, the format of returned data selected from the plurality of formats comprising delimited file, JSON, BSON, and BLOB, one or more target databases of the plurality of databases, database query code, commentary related to logic associated with the database query code, a name for the first query, and an identification of the front-end application associated with the first query;
executing the first query by implementing the database query code associated with the first query against the one or more target databases of the plurality of databases, wherein executing the first query returns retrieved data; and
transmitting the retrieved data in the format of returned data to a user device associated with the front-end application.

10. The system of claim 9, wherein the retrieved data is transmitted to the user device by streaming the retrieved data to the user device.

11. (canceled)

12. The system of claim 9, wherein the query database stores queries with Structured Query Language (SQL) database query code and Non-SQL (NoSQL) database query code.

13. The system of claim 9, wherein the query database is managed independently of a codebase associated with the front-end application.

14. The system of claim 9, wherein the query database automatically interacts with the front-end application as a microservice.

15. A computer program product comprising one or more computer readable storage media, and program instructions collectively stored on the one or more computer readable storage media, the program instructions comprising instructions configured to cause one or more processors to perform a method comprising:
identifying, in a query database, a first query associated with an identifier, a version number of the first query, and parameters received from a front-end application, wherein the parameters comprise a format of returned data selected from a plurality of formats and a body comprising input parameters required by the first query, wherein the query database stores a plurality of preconfigured queries and is communicatively coupled to the front-end application and a plurality of databases, and wherein the query database comprises, for the first query, the identifier, the version number, the format of returned data selected from the plurality of formats comprising delimited file, JSON, BSON, and BLOB, one or more target databases of the plurality of databases, database query code, commentary related to logic associated with the database query code, a name for the first query, and an identification of the front-end application associated with the first query;
executing the first query by implementing the database query code associated with the first query against the one or more target databases of the plurality of databases, wherein executing the first query returns retrieved data; and
transmitting the retrieved data in the format of returned data to a user device associated with the front-end application.

16. The computer program product of claim 15, wherein the retrieved data is transmitted to the user device by streaming the retrieved data to the user device.

17. (canceled)

18. The computer program product of claim 15, wherein the query database stores queries with Structured Query Language (SQL) database query code and Non-SQL (NoSQL) database query code.

19. The computer program product of claim 16, wherein the query database is managed independently of a codebase associated with the front-end application.

20. (canceled)

21. The computer-implemented method of claim 1, wherein the format has data type string and is selected from a group consisting of: csv, json, and xml, and wherein the body has data type JSON.

22. (canceled)
